(19) United States
(12) Patent Application Publication
(10) Pub. No.: US 2011/0066575 A1
(43) Pub. Date: Mar. 17, 2011

(54) Square deal marriage contracts-R-Us franchise

(75) Inventor: Brian Bras Taylor Dobane, Newark, NJ (US)

(73) Assignee: Brian L. Taylor aka Bras Dobane

(21) Appl. No.: 11/890,240

(22) Filed: Aug. 6, 2007

(51) Int. Cl. G06Q 90/00

(52) U.S. Cl. 705/500

(57) ABSTRACT

Square Deal Marriage Contracts R Us is a contracted matrimonial process where-by two people agree to marry for a limited amount of time; a term. The contract will be used to solidify the union, but will last only as long as the marriage term itself, which can range between three years, five years, or a customized term containing its' own set of years. Couples can also resign (that is, sign again) at term's end while retaining all previously acquired assets and liabilities (a requirement of them before the marriage), or they can allow the marriage term to end without renewal, then remarry someone else if they choose. This emerging product has it all.

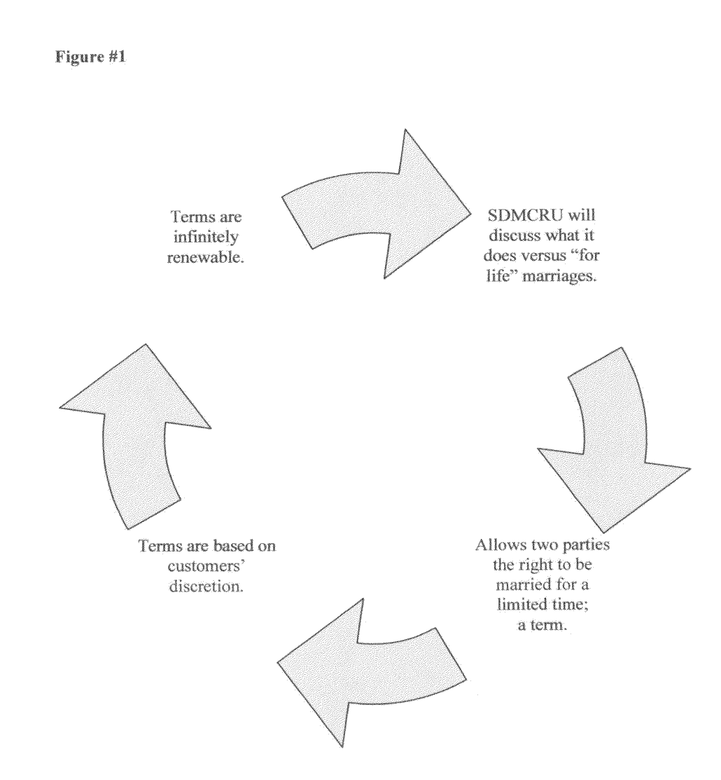

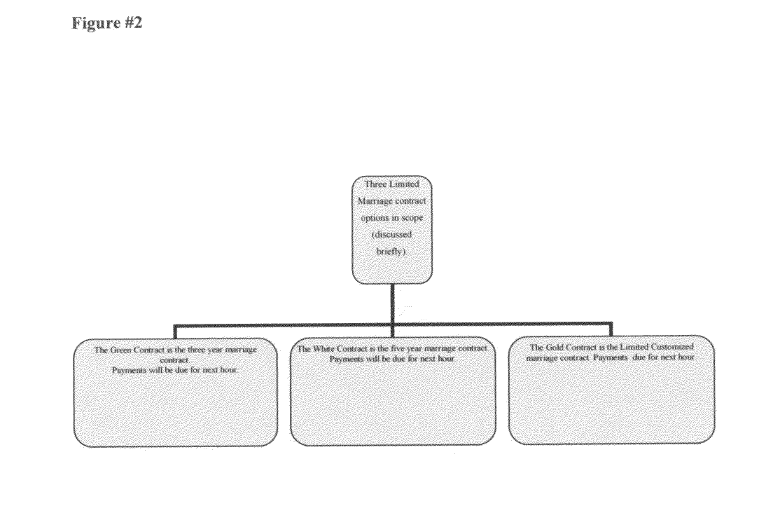

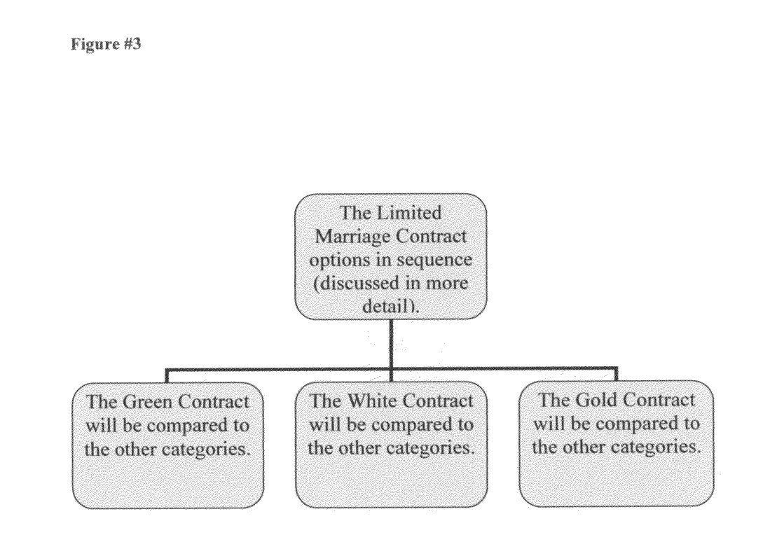

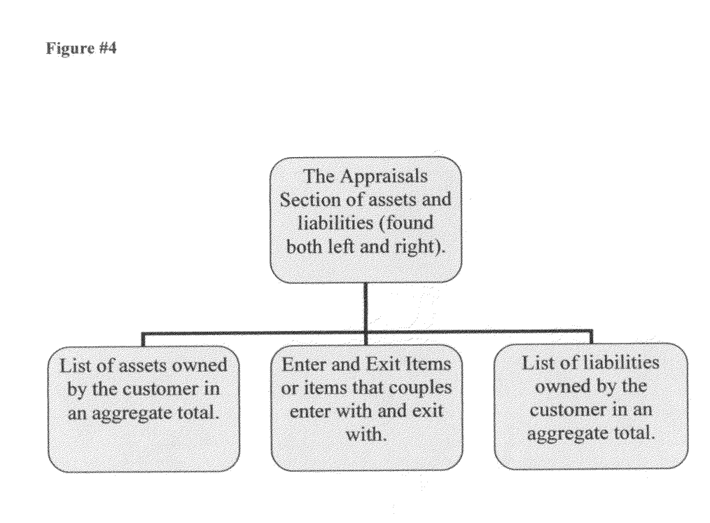

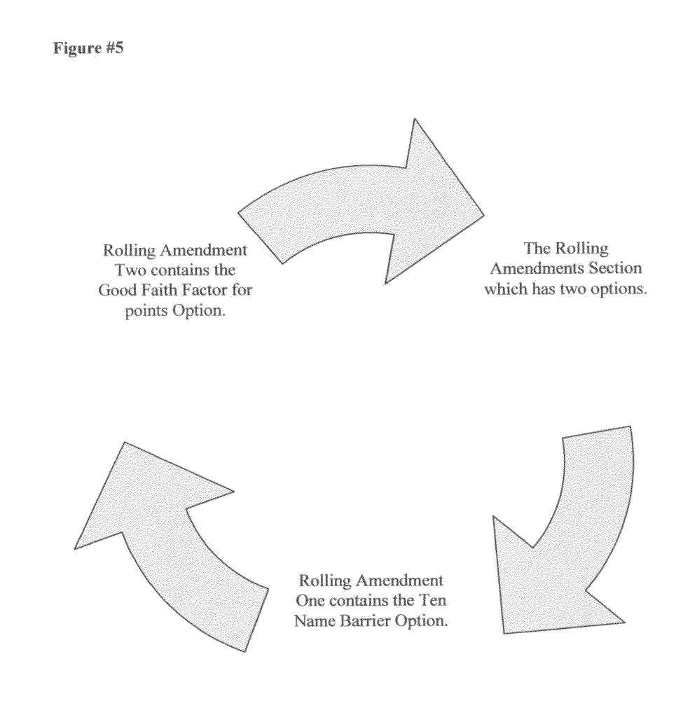

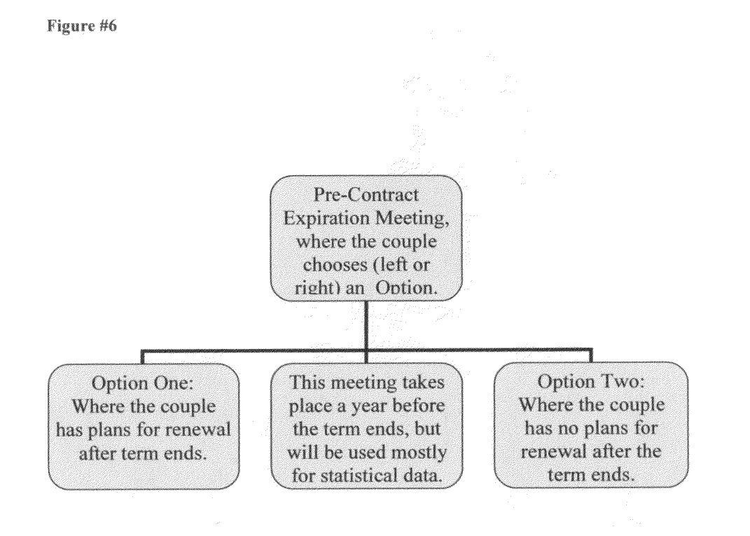

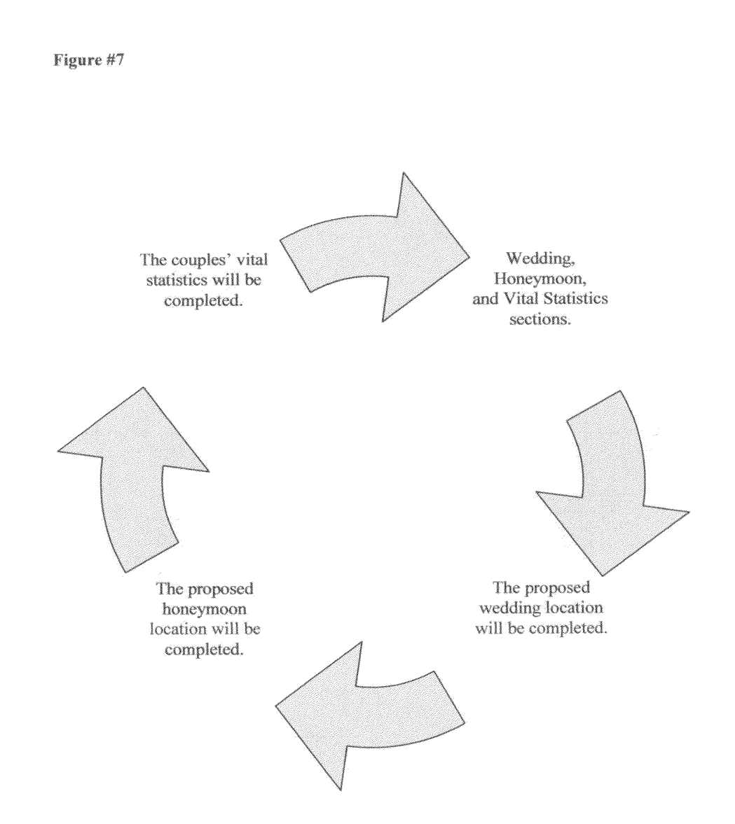

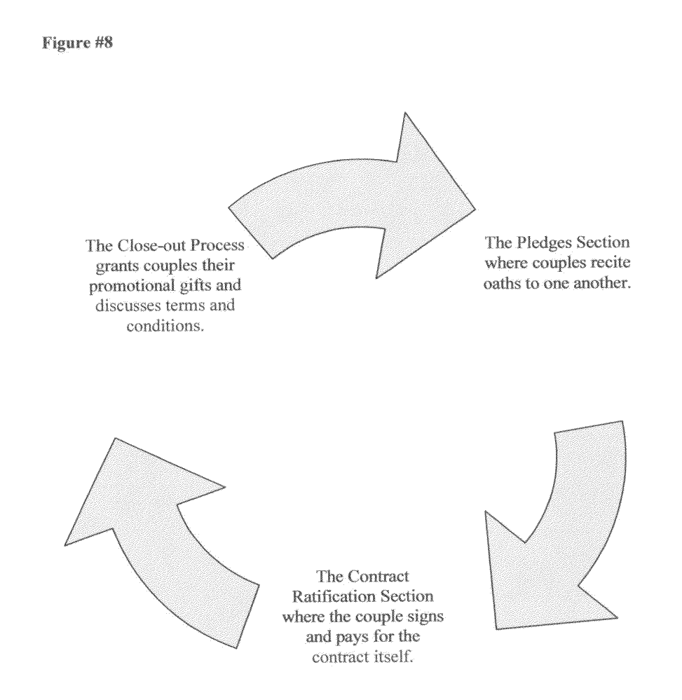

### DETAILED DESCRIPTION OF THE INVENTION

### With Substitute Specification

1. The prevailing manner in which Ed Wood will operate is through its association with its Parent and Holding Company, SDMC or Square Deal Media Communications, LLC. And it's servicing companies, the college-based Ed Wood UCAU or United Collegiate Artists Unlimited and the community based Ed Wood UCAU (P) or United Community Artists Unlimited (Professional Branch).

This association or triangle is emphasized through various steps. They include the following:
a. First, a community-based Chapter Of The UCAU (P) is formed into a regular small business. This organizational business, which contains all motion picture professionals and maturing professionals, undertakes and completes a film project along with advertising, so that the project is otherwise ready for release.
b. That film and its Advertising Kit are then sent to SDMC's main Headquarters for selection.
c. If selected, an account is set-up with that company where they will split the cost of duplicate Blu-Ray or most current DVD format or otherwise with Ed Wood and Ed Wood will send a DVD with all Advertising Pictures and literature to all campus-based UCAU Chapters who will then mark their release dates while preparing it on campus for a “Release Run.”
d. Once released the film is tracked through ticket sales and is otherwise reported to SDMC each day. Now, if the run is successful, proceeds are electronically sent back to SDMC for distributive pay, operational expenses, re-investment, etc. Once a film's run becomes light or its attendance is lessening then a new film takes its place where the process on each campus continues and continues.
e. All DVDs and any Advertisements left will returned back to SDMC who will handle and stock a portion as the official center of records.
   aa. Once a film is distributed through this medium part of the copies are retained for archival prosperity and can be exhibited under more flexible terms, when and if that point becomes necessary, that project is needed or required (shopping-it for more use).
   SDMC will return all other copies and ads back to its Ed Wood UCAU (P) Chapter film company. That company can then submit them for “Professional Release,” straight-to-DVD, etc. through other means along with using ED Wood status and prestige as a reference.
f. If a Red Carpeted Premiere, one Campus Ed Wood UCAU is sent packages (containing various instructions as they are set to change, from visitor to visitor) weeks in Advance so that Campus Ed Wood UCAU may prepare at least one night lodging, food, and travel for any invited guests to the red carpeted premiere. SDMC, as the apex of this triad, initiates the program time and again.

1B. SDMC introduces Ed Wood to higher Ed America by forming Ed Wood UCAU Chapters to every college campus in the country. Each college campus is given an instructional DVD which explains how ED Wood UCAU chapters are formed.
a. Once a campus decides to adopt a Chapter, the Chapter is formed, offices are elected, and the organizational Chapter launches.
b. Once launched, the Chapter President receives a second DVD on Campus Mini Theater Operations or a “Campus Mini Theater Manual,” which will thoroughly cover all aspects necessary for students to run a successful Campus Mini Theater. This DVD is retained by each chapter as a reference (but has not been produced as of this time).
c. The newly established Ed Wood UCUA organization receives its charter and prepares their chapter for exhibiting Season by forming or readying their Campus Mini Theater for scheduling, producing and formally hosting both, regular and Red Carpet movie premieres.
d. Through SDMC, the campus Ed Wood UCAU Chapter receives its Advertising Packages from SDMC and from the Ed Wood UCAU (p) film company or film companies that produced the film.
e. The first component of a new Advertising Package is a trailer of the film, which has not reached the campus yet, only the trailer of the film to be released. That trailer is now placed with other trailers of like status either in a pile to be each played as a series before a movie, or edited together as a series and played before a movie. Subsequently, that trailer gets played before a movie.
f. Within the next week or two a sufficient number of SDMC advertisements are sent to Ed Wood UCAU Chapters, whose campuses vary in size; they will request only what is their standard portion in relation to the size of their school. Six weeks before a regular premiere the Ed Wood UCAU Mini Campus Theater staff (officers) will give them to the Base Officer, present at the campus office at all times, who will allow teams of UCAU rank and file to post them and set them in only campus approved areas. Six weeks in advance, tickets go on sale which can be at least 25% cheaper than the regular ticket sales, particularly if the movie becomes a blockbuster nationwide.
g. Through SDMC, the Campus UCAU chapter will now receive a DVD of the movie, more than likely a week before the premiere. This DVD itself, will be given to the President or Base Officer for safe-keeping.
h. The day of the premiere a previously Advertised poster is labeled “Now Playing,” and receives a small paraphernalia/memorabilia display containing free final give-a-ways and gifts, which will be allowed an exclusive corner of the Mini Campus Theater lobby, but only for that day.
i. After each day of exhibition all films are stored in the office safe, and under no circumstances are to be sold, reproduced, or rebroadcasted without the exclusive consent of SDMC and the Ed Wood UCAU film company sponsor. From that point the process repeats everyday from August to June, with a possible place in the summer, later-on. Campus UCAU chapters make roughly ten percent off of every dollar earned from ticket sales.

2A. Red Carpet Premieres will be huge events for Ed Wood in which predicted block buster or bigger budget movies receive a star-student studded and even Hollywood studded visit and exclusive viewing, which takes place on a scheduled campus and on a scheduled evening. This evening takes place a day before the film is to premiere around the country and world.
a. Through SDMC, the campus UCAU Chapter will receive a DVD trailer of a big or bigger budget movies, set for Red Carpet premiere. One to two weeks later the Advertisement Package will be received with Advanced Tickets.
b. SDMC will then send them an advanced itinerary of the event's schedule, plus travel and lodging requirements for each invited guest. Six weeks prior to the Red Carpet Premiere that campus UCAU Chapter is inundated with work. They, with the help of their University president will help to book all reasonable travel and hotel lodging for both Ed Wood and or Hollywood talent along with enough space for a one day UCAU seminar and meet-and-greet occurring before and after the premiere. Now because of the large volume of colleges, Red Carpet Premieres may occur once a year, on a campus if at all, although UCAU (P) guest seminars occur more often.
c. SDMC first deals directly with the UCAU film Company Sponsoring the film and with any Hollywood agents and or publicists, which is when and how each schedule and itinerary is arranged; everything surrounds the talent. SDMC then generates the information and sends via email, fax, etc. the entire customized schedule and itinerary.
d. Five weeks before the event, SDMC meets with a chosen UCAU college chapter president, executive officer(s), and university president in order to tour the sight locations proposed for the RC Premiere. The UCAU and the university may split these charges. Naturally all parties communicate daily throughout this time in order to ensure a smooth red carpet premiere. These groups design a SDMC/Ed Wood standard press kit and gift package for that UCAU campus theater.
e. The weeks leading to the Red Carpet Premiere are particularly busy periods for that campus UCAU chapter as many tasks and deadlines must be met with timelessness and efficiency.
   aa. Gift Kit materials may be sent to the Campus UCAU chapter from SDMC along with a sample that will be in a crush proof box. At that point the rank and file should be shown a demonstration, then straight to work.
   bb. During these weeks all other materials shall be purchased for decoration to take place in all event rooms. Those rooms will be adorned in that school's colors, except the Mini Campus Theater, which will be the official colors of Ed Wood (or royal blue and gold). Most rooms will be set-up one week to two days before. During this time the regular movie exhibiting schedule hasn't stopped because its operation is perpetual during the season. Decoration must start after work the last two days before the Red Carpet Premiere. The actual screening room for the Red Carpet Premiere should be cleaned and ribboned-off two days prior.
   cc. In advanced, schedules with the event room will be made; hotel lodging, travel, and other itinerary will be completed and locked-in. New, more updated information and correspondence will be exchanged between the campus UCAU chapter and SDMC daily; every inch of the process will be completed by the office before the premiere.

2B. The day of the Red Carpet Premiere will be the day when some of the main talent responsible for making the film appear at the school for a work shop (courtesy of the talent) and for the Red Carpet Premiere.
a. That morning all talent will start receiving lodging and travel accommodations the minute they land or arrive.
b. The Premier Brunch takes place about ten AM. All talent must be taken there.
c. The Professional Seminars which take place after the brunch and will run from one to six.
d. By seven o'clock the crowd should be gathering for the Red Carpet where final tickets if any, will be sold at this time.
e. All talent arrives at seven thirty for a fifteen minute photograph moment, then everyone assembles in the meet and greet with finger food and water or soft drinks; juice.
f. By seven fifty all talent should be inside of their ribboned locations followed by the advanced ticket holders who should be seated promptly.
g. The Red Carpet Premiere will span from eight to ten for regular features and from roughly eight to eleven for epic features.
h. Following the Red Carpet Premiere will be the post Premiere Networking Gala which will be held in a large space such as a pre-decorated gym or campus hall space and tasteful. At this point our visitors and hosts are formally allowed to network with one another. There, the UCAU member company president or representative will be presented with a Worldwide Premiere Award. This event lasts for roughly an hour.
i. At this point the Gala will draw to a close where the hosts and guests engage in a formal toast where the UCAU themed song or ritualistic creed will be read or recited and they drink on behalf of good luck to the UCAU and Ed Wood. The guests then leave. This event lasts for about thirty minutes. Campus UCAU chapters make roughly ten percent off of every dollar earned from ticket sales.

3. Screenwriter Program will be UCAU and Hollywood generated but will be conveyed through SDMC. Professional screenwriting will always lead the touring season. SDMC will select UCAU (P) professionals or Hollywood Professionals to take trips to various UCAU (P) chapters around the country where they will conduct half and full day seminars which deal with that particular chosen field.

The screenplay Program will spearhead this series which will continue with subsequent seminars for each and every fundamental position found on a film set. So that by season's end or by the school year's end seminars will have taken place for every position, which will rotate back to the screenwriter program (the following school year).
a. The Touring Seminar Series will start with the Ed Wood Screen Writing Series which will run from August to September. Only professional screenwriters will be available for touring seminars at that time.
b. SDMC will send their UCAU (P) and or Hollywood professional screenwriters to campus UCAU chapters all over the country and world to teach fundamentals of that particular craft to those UCAU student bodies.
c. These seminars will be half day and or full day events to be held in a lecture hall that has been previously sanctioned by and through the school. These seminars, like Red carpet premieres will be “day only” events.
d. At the close of each Ed Wood Touring Seminar Seminar day campus UCAU chapter members will then network with this professional any screenplays, ideas, or goals that are of interest to that student member, Then through business card exchange a relationship can be formed.
e. Campus UCAU chapter members will then, through sub-committees, start researching, writing, and editing their screenplays with hopes of forwarding them to that UCAU (P) or Hollywood professional.
f. Before the work is submitted copyrights are completed for each of them. Next, the campus UCAU boards will select the two most compelling stories, that will be sent to the visiting UCAU (P) and or Hollywood professional.
g. The UCAU (P) and or Hollywood professional will more than likely tour every campus in his or her circuit, therefore at least fifty of the best professionals will be employed here. A minimum of two stories for every campus are read by that UCAU (P) and or Hollywood professional where the UCAU (P) chapter votes on whether the screenplay should be purchased and developed into a film. Naturally, correspondences and rewrites will take place between the student member and professional during the process. Final Draft or another brand of screenplay software will be purchased for each chapter at each school.
h. If a screenplay is selected then that UCAU (P) and or Hollywood representative will contact the writer from that Campus UCAU chapter for a meeting.
i. That student UCAU chapter member will be then flown to or taken to that UCAU (P) chapter sight and offered the standard UCAU and Ed Wood rate for a screenplay purchase which will be set roughly between five thousand to ten thousand dollars a story.
j. Once an student UCAU member accepts the offer he or she is immediately cut two checks: a ninety percent check is for the student member for the story rights with writer's credit and a five to ten percent profit participation off of every dollar made on it from sales. The second check is a ten percent check to be paid to that student's campus UCAU chapter, toward their operating budget.

4. The producing, Directing, and Casting Touring Seminar will immediately follow the Screenwriting Touring Seminar Series and will be a simultaneous three part demonstration dealing with the production side of a film, the directorial facet of a film, and the casting director's side of a film. The seminar will start with an overall demonstration during the first half of the day, and will split off into three separate simultaneous sub-seminars that will cover most of the time remaining
a. This second seminar will take place between September and October. During this time only professional producers, directors, and casting directors will be on the Touring circuit.
b. SDMC will send these UCAU (P) and or Hollywood professional producers, directors, and casting directors to campus UCAU chapters all over the country and world to teach fundamentals of those particular crafts to those student bodies.
c. These seminars will be half day and or full day events which will be held in separate lecture hall rooms that have been previously scheduled by and through the school. These seminars, like Red Carpet Premiere seminars will be “day only” events and will focus only on those student UCAU chapter members only interested in Producing, Directing, and Casting.
d. At the close of each Ed Wood Touring Seminar Day, campus UCAU chapter members will then network with these professionals any short films, play credits, goals, ideas, etc. to these individuals. Business cards are exchanged where relationships could be formed.
e. Campus UCAU chapter members will then, through sub-committees start planning, casting, and directing newer or more short video with the hopes of forwarding them to that UCAU (P) or Hollywood Professional (all short scripts will be written by the chapter UCAU screenwriters.
f. Before the work is submitted copyrights are completed for each short film completed. Next, the campus UCAU boards will select the two most artistically compelling stories which will be sent to the visiting UCAU (P) and or Hollywood Professional.
g. The UCAU (P) and or Hollywood professional will more than likely tour every campus in his or her circuit, therefore fifty of the best professionals will be needed. A minimum of two shorts for every campus are screened by that UCAU (P) and or Hollywood Professional where the UCAU (P) chapter votes on whether that campus Producer, Casting Director or Director should be contacted for a summer apprenticeship. Naturally, active correspondence will take place between the student member and professional during the process.
h. When and Producer, Director, or casting Director is selected that UCAU (P) and or Hollywood representative will contact the student Producer, Casting director, or Director from that chapter either from one school or in this case three schools (because not all positions may be selected from one particular school).
i. The selected UCAU Chapter members will be then contacted over the phone, email, etc. then told where to report during the Thanksgiving or Christmas vacation. A small meeting may be required at that time in order to finalize their status for the summer.

5. The Photography and lighting/gaffing Touring Seminar will follow the Producing, Casting Directing, and Directing seminar and will center around Motion photography (or the actual shooting of the movie), Still Photography (or the capturing of scene shorts in frozen form), and gaffing (or the art of lighting), when on a film set. The seminar will start with an overall demonstration during the first half of the day, and will split off into three separate simultaneous sub-seminars that will cover most of the time remaining.
a. This Touring Seminar Series will run from November to December and will be based on lighting and photography scenes properly. Only professional motion photographers, still photographers, and gaffers will be available for Touring Seminars at this time.
b. SDMC will send these UCAU (P) and or Hollywood professional photographers and gaffers to campus UCAU chapters all over the country and world to teach the fundamentals of that particular craft to those UCAU student bodies.
c. These split-day events will be held in lecture halls that have been previously sanctioned by and through the school.
d. At the close of each Ed Wood Touring Seminar Day, campus UCAU chapter members will then network with this individual any photography or lighting work done, goals, ideas etc. that are or would be of interest to these individuals. Then, through business card relationships are formed.
e. Campus UCAU chapter members will then, through sub-committees, start planning lighting, and shooting newer and more (volume) short video movies and still photographs with hopes of forwarding them to that UCAU (P) and or Hollywood Professional (all short stories will written by the campus UCAU screenwriter, all producing will come from the campus UCAU producer, all casting will be done by the campus UCAU casting director, all Directing will be done by the campus UCAU director, all lighting will be done by the captured by the campus UCAU DPs or director of photography, and all still photography will b captured by the campus UCAU still photographer).
f. Before the work is submitted copyrights are completed for each short film completed. Next, the campus UCAU boards will select the two most compelling stories which will be sent to the visiting UCAU (P) and or Hollywood professional.
g. The UCAU (P) and Hollywood professional will more than likely tour every campus in his or her circuit, therefore at least fifty of the best UCAU professionals will be employed. A minimum of two shorts will from every campus are screened by the UCAU (P).
h. When a still photographer, DP, and gaffer is selected that UCAU (P) and or Hollywood representative will contact that student still photographer, DP, and gaffer from that chapter which will range from one school to in this case, three schools for a meeting.
i. The selected UCAU Chapter members will be then contacted over the phone, by email, etc. then told where to report during the Christmas vacation for a small meeting.
j. Important Note: during this time campus UCAU chapter members who are aspiring actors should be meeting with campus UCAU chapter members who are gaffers and still photographers for headshots.

6. The Make-up, Wardrobe, Art Department and Script Supervisor Touring Seminar Series will follow the Photography and Gaffing/Lighting Touring Seminar Series and will focus on Make-up, Wardrobe, set-design and maintenance (Art Department), and Production Supervisor and staffing management when on a film set. The seminar will began as an overall demonstration during the first two hours of the day, then will split off into three separate simultaneous sub-seminars which will cover the rest of the day.
a. The Touring Seminar Series will only run all of the month of December, right up until the winter/holiday vacation recess and is extremely important, but will nonetheless focus on how to build sets, how to properly dress actors to match their set, how to Make-up your actors in order to match their Wardrobe and sets, then how to keep up with what's in each set with with regard to each made-up and Wardrobe(d) actor and what are PAs are and how best to manage them as they assist security in stabilizing the set for your Make-up and Wardrobe actors and actresses.
b. SDMC will send these UCAU (P) and or Hollywood professional make-up artists, wardrobe artists, Production and Script Supervisors, and art and Animation artists/set builders to campus UCAU chapters all over the country and will work to teach students the basic fundamentals of making up actors, dressing actors, building the best set, managing sets through Pa's and managing every inch of what's on set, and basic animation, while on a film set.
c. These split day events will be held in a lecture hall that has been previously sanctioned by and through the school. These particular seminars will be two-day events, instead of the one day only seminars.
d. At the close of each Ed Wood Touring Seminar Series Day campus UCAU chapter members will then network with these individuals any previous professional or work experiences with any of those fields completed in the prior that would be of interest to those individuals. Then through business card, relationships can be started.
e. Campus UCAU chapter members will then, through sub-committees, start building sets, making-up actors, designing wardrobes for actors on sets, practice managing what's on sets, and any staffing, and the basics of animation and shooting newer or more short video movies with the hopes of forwarding them to that UCAU (P) or Hollywood professional (all scripts will be written by the campus UCAU screenwriter(s), all producing will come from the campus UCAU producer(s), all casting will come from the campus UCAU casting director(s), all directing will be done by the campus UCAU director, all lighting will come from the campus UCAU gaffer(s), all motion photography will be captured by the campus UCAU DPs, all still photography will be captured by the campus UCAU still photographer, all make-up applied to the actors will be done by the campus UCAU make-up artist(s), all Wardrobe used to dress the actors will be done by the campus UCAU Wardrobe artist(s), all sets designed will be done by the campus UCAU set designer, all script supervising and production supervising will be done by the campus UCAU script supervisor/production designer(s), and any necessary animation for these films will be done by the campus UCAU animation artists and or department).
e. Before the work is submitted copyrights are completed for each short film completed. Next, the campus UCAU boards will select the two most compelling stories which will be sent to the visiting UCAU (P) or Hollywood professional.
f. The UCAU (P) and or Hollywood professional will more than likely tour every campus in his or her circuit, therefore at fifty of the best UCAU professionals will be employed. A minimum of two shorts from every campus are screened by the UCAU (P) and or Hollywood professional where the UCAU Chapter votes on whether that make-up artist(s), wardrobe artist(s), set designer(s), script supervisor(s) or production supervisor(s), or animator should be contacted for a summer apprenticeship. Naturally active correspondence will take place between the students member and professional during the process.
g. When make-up artist(s), Wardrobe artist(s), set designer(s), and set designer(s), script or production supervisor(s), or animator(s) is selected that UCAU (P) and or Hollywood representative will contact that/those student make-up artist(s), Wardrobe artist(s), set designer(s), script or production supervisor, or animator from that Chapter or chapters for a meeting.
i. The selected UCAU chapter members will be then contacted over the phone and told where to report during the Christmas or even spring break for a small meeting.

7. The Editing, Scoring, and Sound Touring Seminar Series will follow the Make-up, Wardrobe, Art Department, Script or production supervisor and animation Touring Seminars Series and will focus on sound operations and sound effects, editing, and scoring when on a film set. The seminar will be separated into three simultaneous sub seminars which will take place the entire day.
a. The editing, scoring, and sound touring seminar will take place between January through February. During this time only professional editors, musical scoring composers and or conductors and sound making and effects people will be on the circuit.
b. SDMC will send these UCAU (P) and or Hollywood professional editors, musicians, and audio/sound people to campus UCAU chapters all over the country and world to teach fundamentals of these particular crafts to those student bodies.
c. These seminars will be held in separate lecture halls previously sanctioned by the school. These seminars, like the Red Carpet Premiere Seminars will be “day only” events.
d. At the close of each Ed Wood Touring Seminar Series Day, campus UCAU chapter members will then network with these professionals any short films, play credits, ideas, work done, etc. that are or would be of interest to these individuals. Then, through business card exchange relationships can be formed.
e. Campus UCAU chapter members will then, through sub-committees start planning projects on video or film that showcases their editing, scoring, and sound abilities with the hopes of forwarding them to that UCAU (P) and or Hollywood Professional (all scripts will be written by the campus UCAU screenwriter(s)), all producing will come from the campus UCAU producer(s), all casting will come from the campus UCAU casting director(s), all directing will be done by the campus UCAU director, all lighting will come from the campus UCAU gaffer(s), all motion photography will be captured by the campus UCAU DPs, all still photography will be captured by the campus UCAU still photographer, all make-up applied to the actors will be done by the campus UCAU make-up artist(s), all Wardrobe used to dress the actors will be done by the campus UCAU Wardrobe artist(s), all sets designed will be done by the campus UCAU set designer, all script supervising and production supervising will be done by the campus UCAU script supervisor/production designer(s), and any necessary animation for these films will be done by the campus UCAU animation artists and or department, all editing will be done by the campus UCAU editor, all musical scoring will be composed and performed by our musical department with special assistance from the director and editor and the campus UCAU sound team).
f. Before the work is submitted copyrights are completed for each short film completed. Next, the campus UCAU boards will select the two most compelling stories which will be sent to the visiting UCAU (P) or Hollywood professional.
g. The UCAU (P) and or Hollywood professional will more than likely tour every campus in his or her circuit, therefore at fifty of the best UCAU professionals will be employed. A minimum of two shorts from every campus are screened by the UCAU (P) and or Hollywood professional where the UCAU Chapter votes on whether that editor, sound man, and scoring group or ensemble should be selected for a summer apprenticeship and the recommendation is voted on. Naturally active correspondence will take place between the student member and professional during the process.
h. When an editor, sound operator, or scoring ensemble/group is selected that student editor, sound person or scoring ensemble/group/engineer will be notified from either that chapter or chapters for a meeting.
i. The selected UCAU chapter members will be then contacted over the phone and told where to report during the spring break for a small meeting.

8. The Campus Mini Theater Management and Concessions Touring Seminar Series will follow the editing, sound, and scoring seminar and will focus on the essentials of more efficient Campus Mini Theater management and concessions. The seminar will be a full day seminar.
a. The Campus Mini management and concessions Touring Seminar will take place from February through March. During this time only professional theater managers and concessions merchants will be on the Touring circuit.
b. SDMC will send to all campuses an updated DVD if the newer and more innovating ways to operate a smoothly conducted campus engine, and concessions wing.
c. This DVD workshop will be perhaps two hours or more and should be viewed by each member of the Campus UCAU chapter, since most members operate them.
d. A second shorter DVD on effective concessions will accompany the one for Campus Mini Theater management. The concessions DVD will focus on newer guidelines and regulations on food service, which all concessions operators and owners must know. The second half of the DVD will discuss newer food items to sale and tips on discovering others.
e. After both DVDs are viewed by all Campus UCAU members they are then to be placed inside of the Chapter safe and subsequently used as a reference or training piece for new members.
f. As soon as possible, Campus UCAU chapter members are to then comply with the new Campus Mini Theater and concessions wing mandate(s). SDMC may once a year conduct DVD sight evaluation documentaries. During a DVD sight evaluation documentary each campus UCAU chapter conducts its own evaluations via DVD which will include the necessary improvements made in documentary to be sent to SDMC for review.
g. If the location is in compliance then their rating will elevate to star status. However, if the location is not in compliance, then the Campus Mini Theater will not be issued their star until it changes are made and included with the documentary.
h. All certificates Of Star Status are issued to complying Campus Mini Theaters because stars ensure Red Carpet premiers at some point.

9. The final three Touring Seminar Series will center how seniors are to possibly start their own Ed Wood Movie Company after graduation, Ed Wood Celebrity conduct, and Ed Wood Scholarship opportunities. These seminars will be separated into three simultaneous sub seminars which will take place the entire day.
a. The Starting Your Own Ed Wood Movie Company, Ed Wood celebrity conduct, and Ed Wood Scholarship Opportunity Touring Seminars will take place from March to April. During this time only UCAU (P) members as starter business consultants and scholarship advisors will be part of this touring circuit.
b. SDMC will send these UCAU (P) or Hollywood professional Ed Wood starter business consultants and scholarship advisors to campus UCAU chapters all over the country and world to teach those UCAU college seniors and others how to start your own Ed Wood film company or how to join the Ed Wood UCAU (P), and then teaching UCAU college freshman through juniors- How to Qualify for Ed Wood scholarships.
The third seminar presentation which deals with ED Wood celebrity conduct will actually be in the form of a down loaded decree that are read by campus Ed Wood UCAU Presidents to their entire staffs. Once these decrees are read aloud they are then stored inside of the chapter safe and used as reference material.
c. These seminars will be held in separate lecture hall rooms that have been previously sanctioned by and through the school. These seminars, like the Red Carpet premiere seminars will be “day only” events.
d. At the close of each Ed Wood Touring Seminar Day, Campus UCAU chapter members will then network with these professionals any information or research already conducted in this field that can help expedite the process. Then, through a business car exchange a relationship can be formed.
e. Campus UCAU chapter members will then, through sub-committees start planning and working in all paperwork necessary to complete post college Ed Wood business application requirements or undergraduate Ed Wood application requirements with the hopes of forwarding the completed criteria back to that Ed Wood UCAU (P) and or Hollywood professional.
f. Before submitted, the information should be looked over by the chapter executive board for errors then sent to either only that UCAU (P) or Hollywood Professional or both that UCAU or Hollywood Professional and whatever state Chamber of Commerce that the college senior place to start it.
g. The UCAU (P) and or Hollywood professional will more than likely tour every campus in his or her circuit, therefore at fifty of the best UCAU professionals will be employed. A minimum of two shorts from every campus are screened by the UCAU (P) and or Hollywood professional where the UCAU Chapter votes on whether that editor, sound man, and scoring group or ensemble should be selected for a summer apprenticeship and the recommendation is voted on. Naturally active correspondence will take place between the student member and professional during the process.
h. Selection ability for all scholarships will be based on its own set of requirements. The ability to receive a business license is contingent upon what particular state requires, however, aside necessary dues usually college UCAU chapter membership carries over with help of a new more updated and completed application.
i. Selected Scholarship Rewards will be sent out by mail where those winners will be notified completely of its conditions and or requirements.
If possible that UCAU (P) chapter(s) will help update and assist that graduating senior on his or her status as a business owner and grant him or her their Ed Wood UCAU membership card.

10. The Ed Wood website will one of SDMC's most efficient forms of communication and will be designed the way that most high resolution websites are conducted
a. This website will contain a series of pages, most of which will be interactive, involving the usage of a specific email address with secret password, for personal access to the site, where available information will be found which include but are not otherwise limited to celebrity news and gossip, movie reviews, Touring Seminar Series Updates, electronic UCAU (P) and UCAU chapter bio-data bases, business bulletins, job bulletins, films developments, films set for a “Release Run,” the application process, etc.

1. Ed Wood is a collegiate version of the Hollywood Studio and movie-making apparatus or system.

2. Through Ed Wood, college and high school students will appear in high quality filmed stories or movies which will be released and exhibited on college campuses around the world, simultaneously.

3. Through Ed Wood, students will write or take part in writing (composing stories or screenplays), either in-person or on-line along with an established screenwriter; an apprenticeship.

4. Through Ed Wood, students will learn and take part in directing actors and actresses via movies alongside established professionals who may be in-between projects; an apprenticeship.

5. Through Ed Wood, students will learn and take part in Gaffing or lighting and work alongside established professionals who may be in-between projects; an apprenticeship.

6. Through Ed Wood, students will learn and take part in Motion Picture and Digital photography by working alongside a professional Director of Photography (DP) who may be in-between projects; an apprenticeship.

7. Through Ed Wood, students will learn and take part in sound making and boom operations by working alongside professionals who are in-between projects; an apprenticeship.

8. Through Ed Wood, students will learn and take part in Art Direction and other techniques such as animation that are necessary for capturing the ideal setting for the actors by working alongside professionals who are in-between projects; an apprenticeship.

9. Through Ed Wood, students will learn and take part in regular Make-up and some special effects make-up by working closely with the Art Direction Department and alongside professionals who are in-between projects; an apprenticeship.

10. Through Ed Wood, students will learn and take part in Costume Design and will work alongside professionals who are in-between projects; an apprenticeship.

11. Through Ed Wood, students will learn and take part in Still Photography for location and studio movie sets alongside professionals who are in-between projects; an apprenticeship.

12. Through Ed Wood, students will learn and take part in Film Production and how to manage schedules, money, time, resources, etc. alongside professionals who are in-between projects; an apprenticeship.

13. Through Ed Wood, students will learn and take part in Production Supervising and Script Supervising and what is expected of a positive, open-minded, and driven Production Assistant, Script supervisor's Assistant; an apprenticeship.

14. Through Ed Wood, students will learn Film Office Management and what is to be expected of a President, Vice President, Secretary, etc. during production and also times when productions aren't taking place, such as between productions.

15. Through Ed Wood, students will learn Editing for Film and Digital Video by learning alongside professionals who are in between projects; an apprenticeship. Student musicians will learn how to compose and play scores from professionals in between projects.

16. Though Ed Wood and the Hosting Institution, students will learn the method of concessions and how to start a concession stand or department.

17. Through Ed Wood, students will learn how to operate any necessary projecting or viewing fundamentals as well as Movie Theater Management Security, prepare for and how to host premiers and how to keep clear financial records, through management professionals.

18. Through Ed Wood, students must form College Chapters of The Ed Wood UCAU or the United Collegiate Artists Unlimited which will serve as the umbrella organization for all members and position types mentioned in all previous Claims who will compose a film making, exhibiting and celebrity-making entity. They will also learn the fundamentals of good advertising particularly from Ed Wood's Parent Company, SDMC or Square Deal Media Communications, LLC.

19. Through Ed Wood, students will learn how to form their own post college Ed Wood Mini film Company with professionals in those positions and what is expected, and how to form Urban, Civilian, Rural, and Sub-urban Chapters of Ed Wood UCAU (P) or United Community Artists Unlimited (Professional Branch).

20. Through Ed Wood, student-made celebrities are instructed how to conduct themselves at all times, and how to prepare for work in Hollywood, or as a working Professional for Ed Wood.

21. Through Ed Wood, scholarships will be set-up or in-part set-up with Hosting Institutions for Thespian and Motion Picture athletes, like sports programs do, where this economy receives its generation and allow them to keep or continue working and staying in school while preparing them for graduation.
